(19) United States
(12) Patent Application Publication
(10) Pub. No.: US 2003/0222067 A1
(43) Pub. Date: Dec. 4, 2003

(54) Semi-automatic welder to close disposable boxes

(76) Inventor: Robinson Shiba, Vila Suzana (BR)

Correspondence Address: KATTEN MUCHIN ZAVIS ROSENMAN, 575 MADISON AVENUE, NEW YORK, NY, 10022-2585, US

(21) Appl. No.: 10/434,889

(22) Filed: May 9, 2003

(30) Foreign Application Priority Data
May 29, 2002 (BR) PI 0202055

(51) Int. Cl. B23K 9/12

(52) U.S. Cl. 219/124.34; 219/125.12

(57) ABSTRACT

SEMI-AUTOMATIC WELDER TO CLOSE DISPOSABLE BOXES, consisting of a box-shaped basic part defined by a lower and an upper platform defining an upper assembly and a lower assembly level, the lower level defining means for built-in assembly of a double-welding set, whereas the upper level configures means to assemble a shaping device, above which a ram device is vertically aligned, mounted on a support that has an inverted “L” shape, defined by a horizontal and a vertical branch, the first being crossed by a transmission and driving mechanism protected by plate surrounding devices, and also such transmission and driving mechanism is, on the one side, operatively coupled for vertical and alternated operation of the ram and, on the other side, it is equally coupled to horizontally operate the double-welding set that, in turn, is electrically interconnected with an electrical control panel, mounted on the back of the base.

### FILED OF INVENTION

This invention refers more particularly to technical and functional improvements especially developed with a view to characterizing a semi-automatic welder, consisting of a shaping set and a set of plates heated by electrical resistances and especially developed to unite and close corresponding parts of disposable boxes used in the temporary packaging of several types of foods.

### BACKGROUND OF THE INVENTION

At present there are numerous fast-food services, traditionally known as food “delivery” services, all of them using disposable boxes and, in some cases, such boxes are normally made of substantially rigid laminar material, such as plastified board paper that is adequately cutout and creased and that, after being folded, forms a true pyramidal trunk box, as shown in FIGS. 1 and 2, where one may see that such box is made from a substantially rigid laminar part, such as board paper plastified on both sides and presents a number of cutouts and creases, which are sufficient for the laminar part to be folded forming a pyramidal trunk box (1) and, at the same time, its upper part includes four closing rims, two (2) of which are folded first, and two other rims (3) are folded on those two rims, whose overlapping ends have respectively an angular slot (4) and a hook-shaped end (5) that are fitted together to complete the closing of said pyramidal trunk box (1) and also two equally triangular rims are formed (6) in two opposed sides of the box (1), one at each vertical corner, and having free ends (7) provided with short slots (8), that are mutually aligned when said rims are displaced, and are placed against the corresponding lateral wall of the box (1) and, in such condition, both rims are united by a metallic clip (9), therefore completing the final assembly of the usual box (1) as shown in FIG. 2. Such boxes, as already mentioned, have impermeable walls and consequently are suitable to pack different types of foods, particularly those with a high degree of humidity, such as Chinese food.

There is no doubt that the above-described boxes developed according to the current state of the technique provide means for the temporary packaging of certain cold or hot foods; however, said boxes have some inconveniencies, particularly as regards the lateral closing defined by the rims (6) and clip (9), because such type of closing, although mechanically efficient, causes some scaling problems, that is, when observing FIG. 1, one may see that each rim (6) consists of a fold or of two wall parts that are continuations of the corresponding lateral walls, forming a space or interstice (10) between them that, in turn, communicates with the corresponding slot (8), where the clip (9) is fitted. Observing FIG. 2, one may see that such fixation point is positioned much below the box (1) upper rim and, for this reason, if the packed food contains a liquid part, it will certainly flow through the interstices (10-8) formed, causing undesired leakages, which occur more frequently when the boxes are used to deliver ready foods, such as Chinese food.

In addition to the above-described inconvenience, it should also be said that the placing of the clip (9) is too slow and requires special care, thus considerably increasing the final packaging cost.

To solve such inconveniences, the Applicant first developed a modified box, described in its U.S. patent application Ser. No. 10/225,618, the substance of which is incorporated herein by reference, which is especially developed to eliminate the fixation defined by the slots (8) and the clip (9) and for such reason different welding lines or thermal welding lines (13) were strategically applied one on each rim (6) as shown in FIGS. 3 to 6, fixing such rim against the corresponding lateral wall (12) of the box (1), whose rim (6) also underwent changes (11-14) to enable different welding lines, but always for the same purpose, that is, to fix the rim (6) against the wall (12) of the box and this resulted in the following advantages:

a) fast box mounting;

b) cost reduction; and

c) tight closing of the interstice (10) formed between the rim (6) walls, thus avoiding undesired leakages.

Therefore, with the above-described improvement, in addition to eliminating items (8-9), there is also a considerable improvement in the packaging tightness, because the whole upper border of each rim (6) is completely sealed. Under such condition, leakages are very hard to occur, even when the food has a large liquefied part and the box is shaken during transportation, such as when ready food is delivered.

On Aug. 3, 2001, the Applicant also deposited Brazilian Application P.I. 0105290-0, under the name “WELDER TO CLOSE BOXES”, more particularly a manual welder specially designed to make welding (13) and its variations, thus providing an efficient manner to eliminate the fixation defined by slots (8) and clip (9), and, for this reason, with such welder it was possible to strategically apply two welding lines or thermal welding lines, one on each rim (6), so as to obtain the aforementioned advantages.

There is no doubt that the “WELDER TO CLOSE BOXES” described and claimed under P.I. 0105290-0 meant an important technological advance to make the preparation of said boxes semi-automatic; however, during use, it was noted that its operation characterized a welding process that, although efficient, is relatively slow, not as regards the welding performance stage, but as regards the packaging itself, because the box must be previously folded manually and then placed between two pressing parts, one of them heated, to perform the welding lines. Therefore, using this welder the box is folded manually, and this requires some time, and also preliminary operations are required before the welding, making the whole process substantially slower.

### OBJECTIVE OF THE INVENTION

Making a semi-automatic welder especially designed to perform two progressive operations, the first being the folding of the box up to its complete shaping so that the welder may then simultaneously perform the two welding operations of the rims (6) on the two lateral walls (12) of the boxes. Therefore, the two operations are performed progressively only with the driving of a lever, and the temperature and the welding time are electronically controlled thus ensuring a continuous and progressive box shaping and welding process that, when compared with that of the previous welder, significantly reduces the time of a complete cycle, making the box welding process even more advantageous.

### BRIEF DESCRIPTION OF THE DRAWINGS

To better understand this Invention, below is a detailed description of said invention, containing references to the attached drawings, where:

FIG. 1 represents a perspective view showing a usual box (1) with open upper rims, and its lateral walls (6) also open;

FIG. 2 shows a perspective view of a usual box (1) completely assembled and closed, highlighting the closing of its side rims using metallic clips (9);

FIG. 3 is a perspective view of the box (1) open and with its rims welded with the current welder;

FIG. 4 shows a view equal to the previous one but, in this case, the box is completely closed;

FIGS. 5 and 6 represent perspective views of the same box, but highlight the fact that the weld as well as the rim (6) of the box may present different geometries;

FIG. 7 is a perspective view showing external details of the current welder;

FIG. 8 shows another perspective view of the welder in question, without however showing some external parts, and highlights its internal devices;

FIG. 9 is an amplified view in frontal elevation partially showing the welder without some of its external coatings. The shaping ram is shown in a cross section in this figure;

FIGS. 10, 11 and 12 show, respectively, two perspective views of the box (1) in a planar or laminar position, and a perspective view of the assembled box, highlighting its creased parts to be folded and welded by the welder in question;

FIG. 13 shows an amplified side view, detailing the set defined as shaping ram that is one of the main sets that shapes the box during the welding process;

FIGS. 14 and 15 show amplified and partial perspective views, highlighting the parts of the lever-driven device;

FIG. 16 shows the welder according to a frontal elevation view, partially as a cross section. In this figure the welder does not have its coating, and its internal devices are highlighted;

FIG. 17 is a partial and amplified perspective view of the double welding set;

FIG. 18 represents a partial perspective view, highlighting the details of the shaping set of the box to be folded and welded; and

FIGS. 19, 20 and 21 are front views showing the operation of this welder.

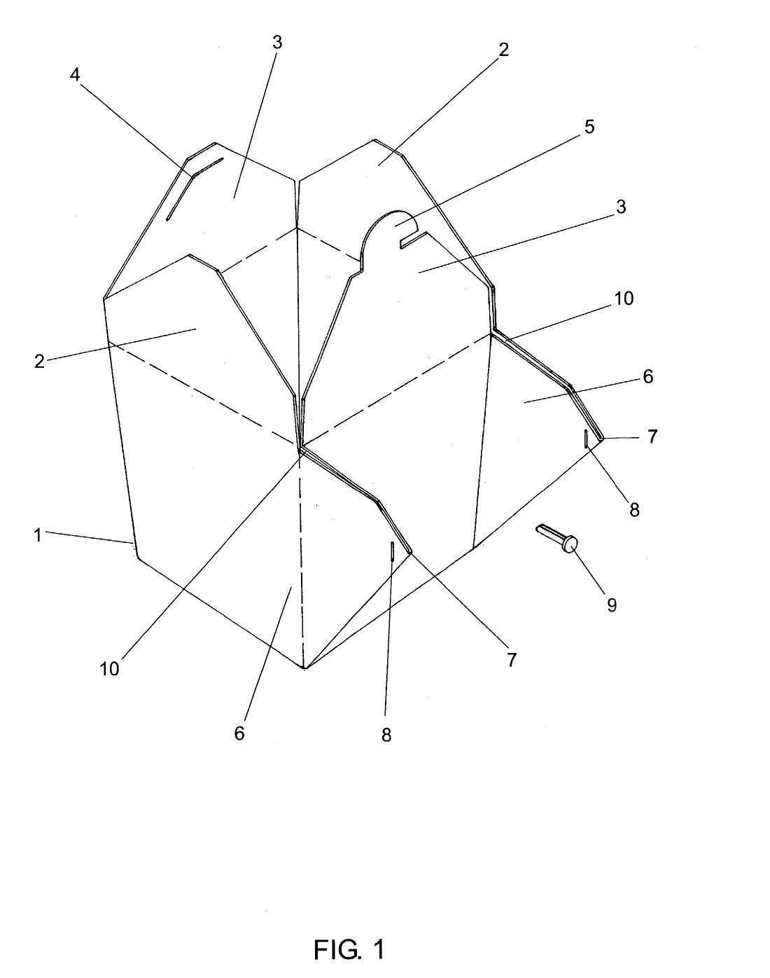

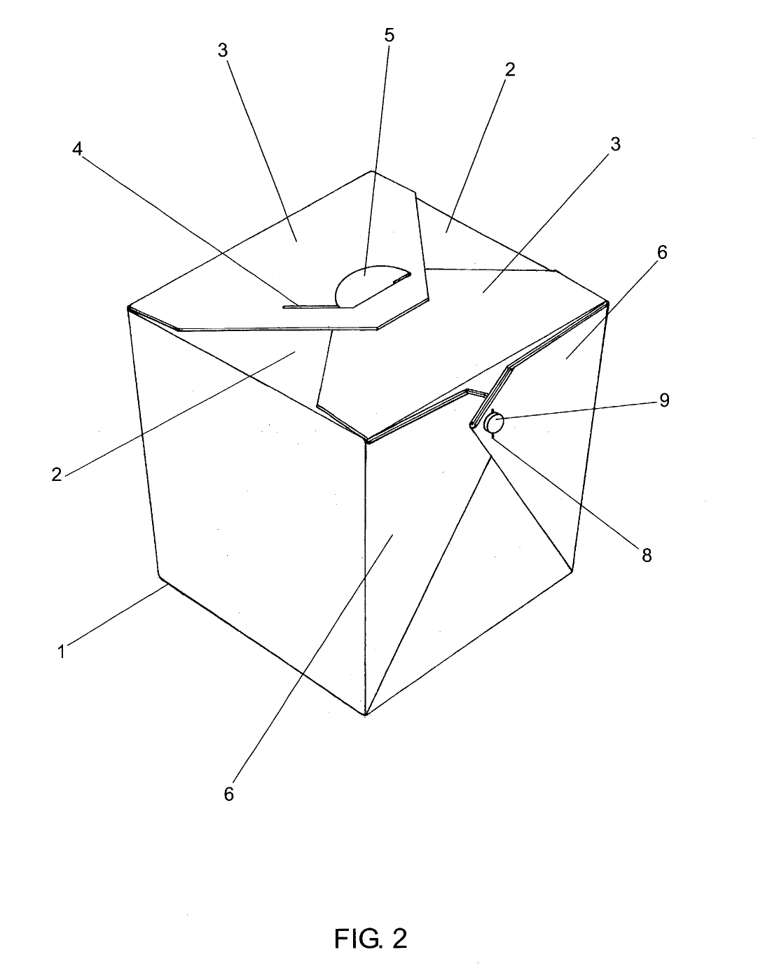

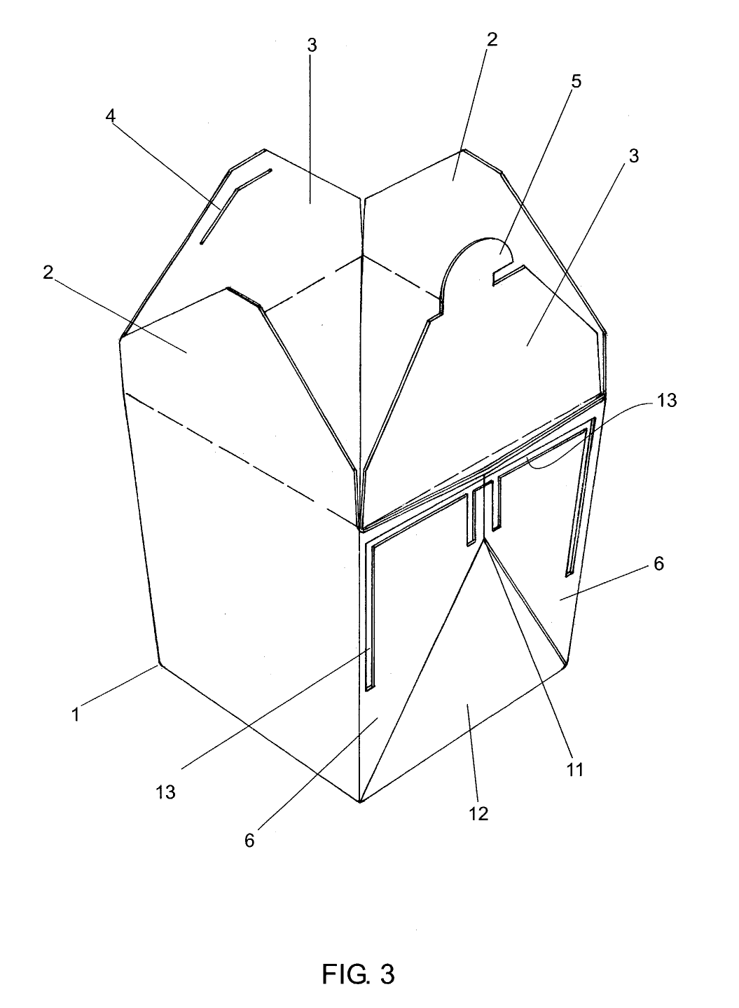

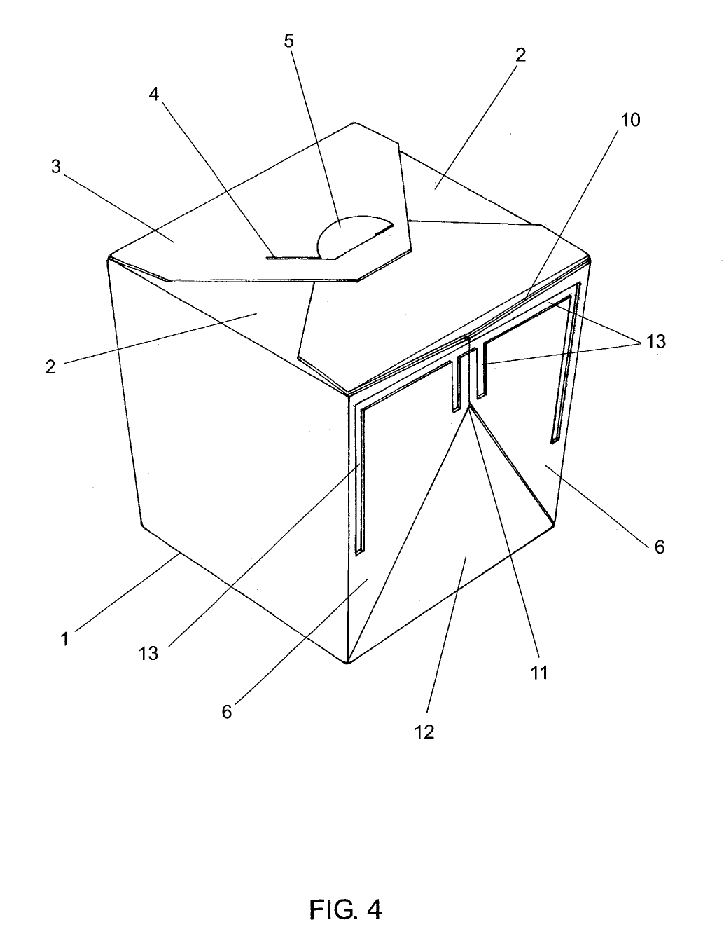

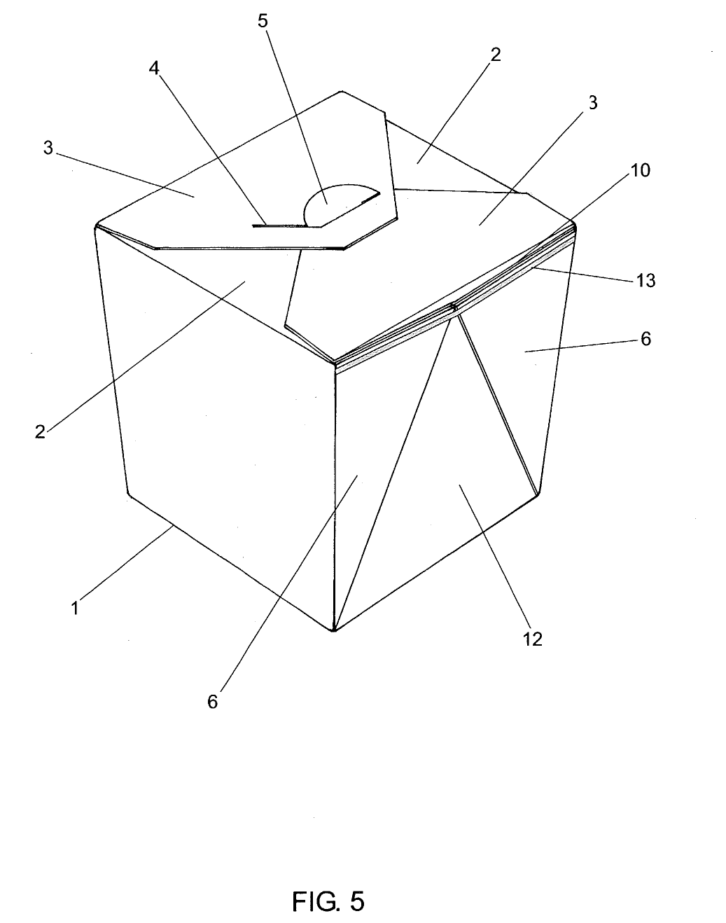

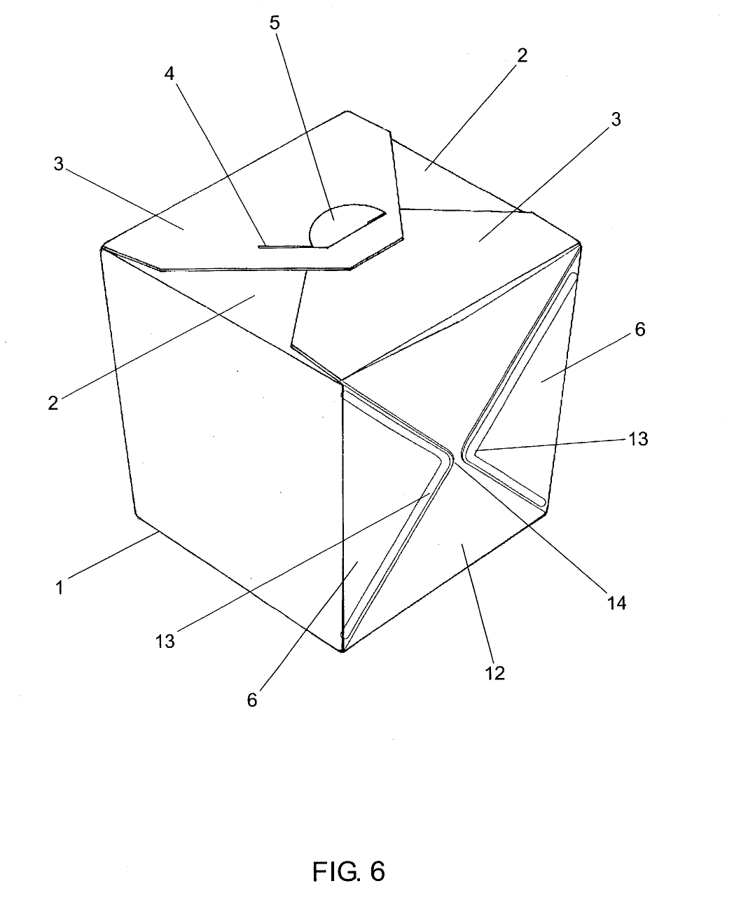

### DETAILED DESCRIPTION OF THE INVENTION

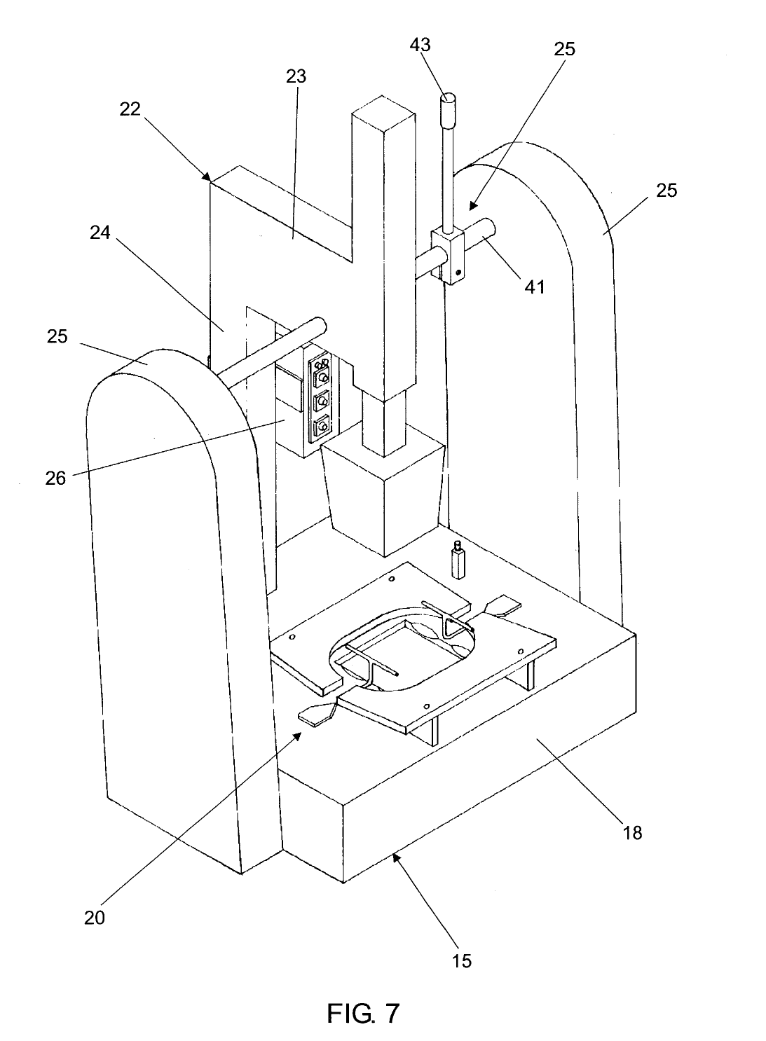

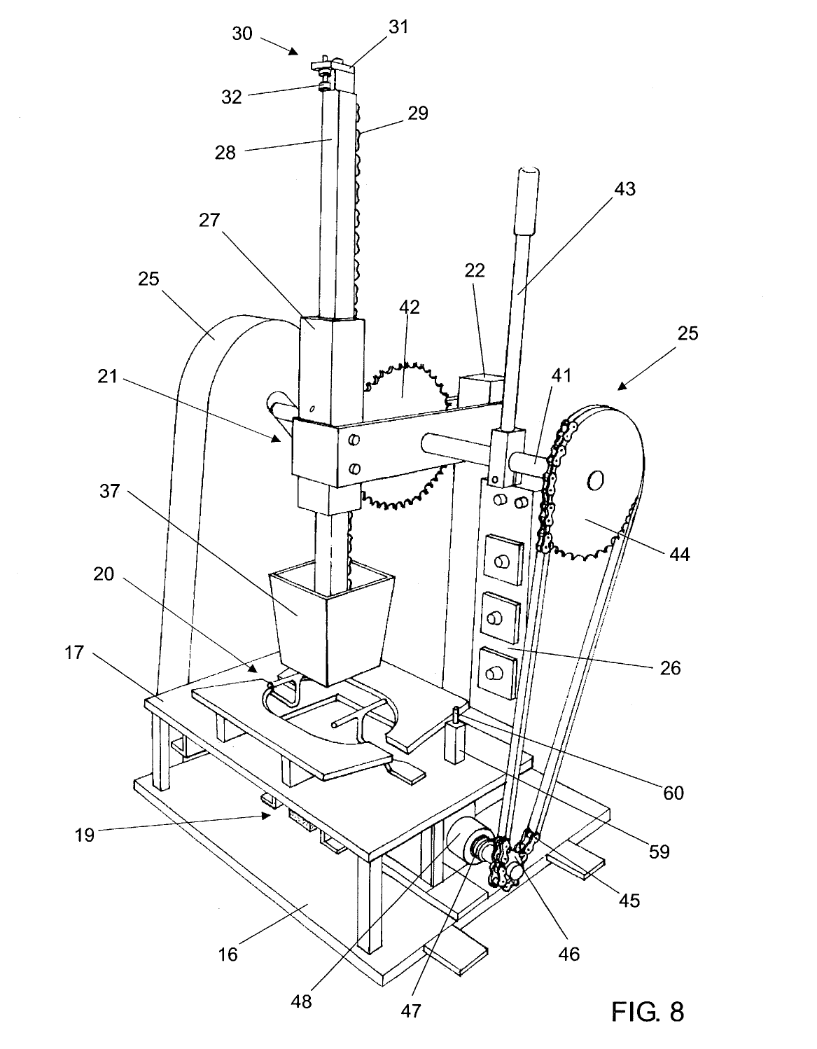

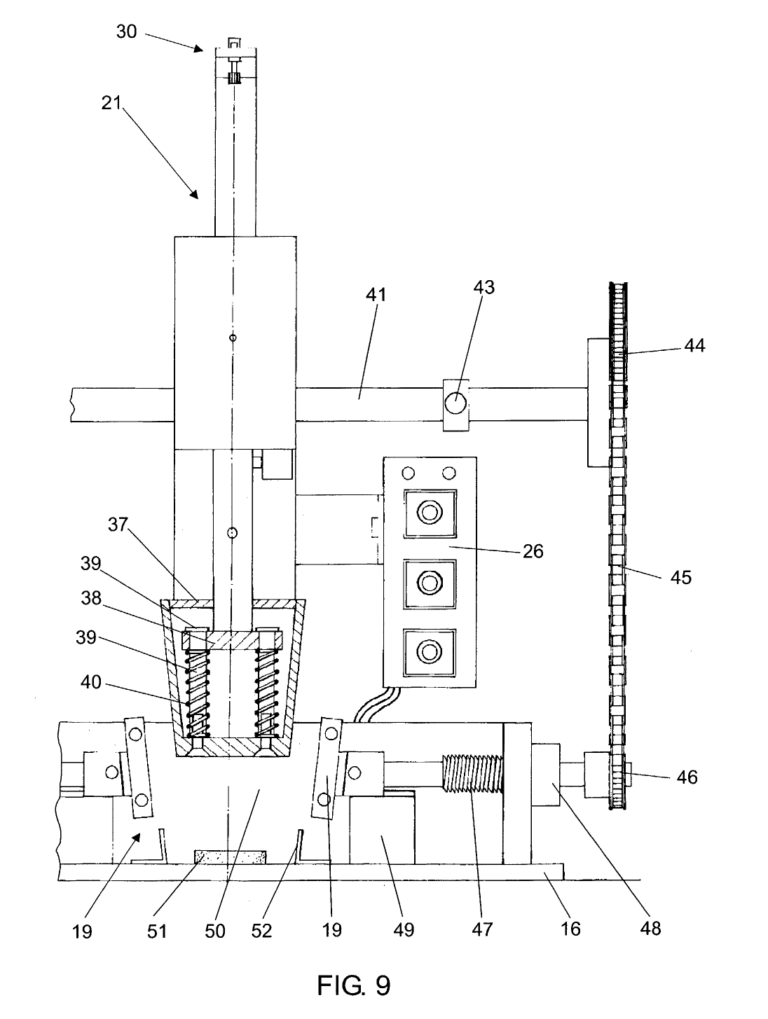

According to the illustrations and respective details, more particularly FIGS. 7, 8 and 9, this Invention, called SEMI-AUTOMATIC WELDER TO CLOSE DISPOSABLE BOXES, is characterized by the fact that it consists of a basic part (15), usually in the shape of a box, defined by two platforms, a lower (16) and an upper (17) platform, defining two assembly levels, an upper and a lower assembly level, and the latter, in addition to including a plate surrounding closing (18), also defines means for built-in assembly of the double-welding set (19), whereas the upper level or platform (17) configures means to assemble the shaping device (20), above which the ram device (21) is vertically aligned, mounted on a support that usually has an inverted “L” shape (22), defined by a horizontal (23) and a vertical (24) branch, the first being crossed by a transmission and driving mechanism (25) protected by plate surrounding devices (25′), one on each side, and also such transmission and driving mechanism (25) is, on the one side, operatively coupled for vertical and alternated operation of the ram (21) and, on the other side, it is equally coupled to horizontally operate the double-welding set (19) that, in turn, is electrically interconnected with an electrical control panel (26), mounted on the back of the base (1).

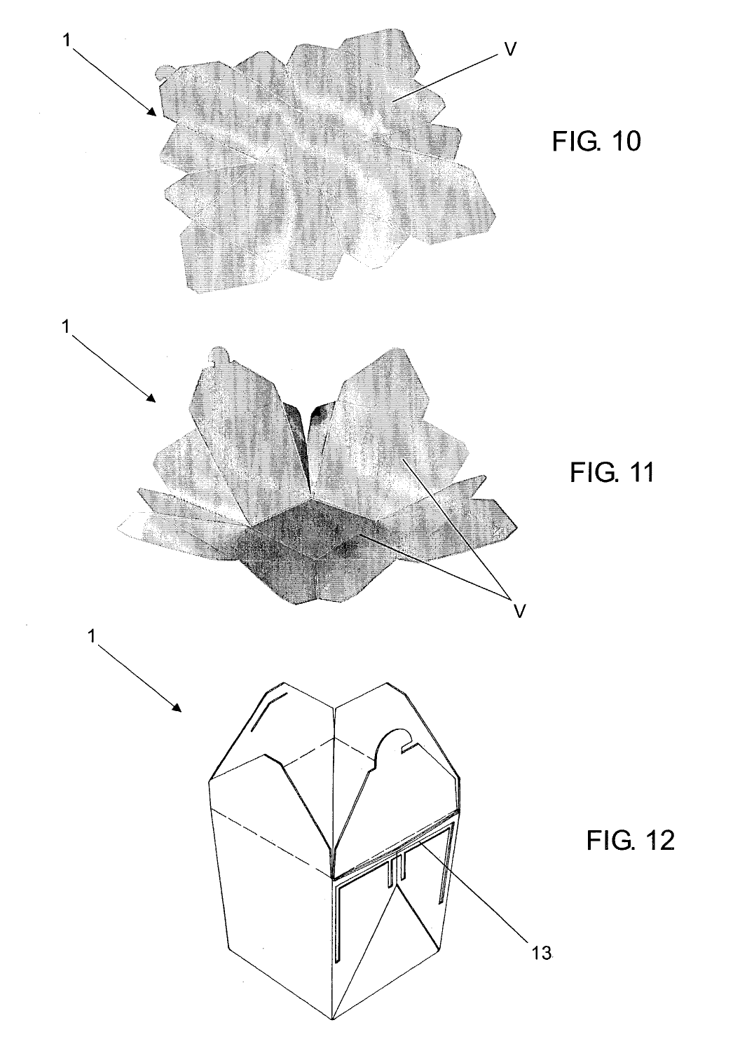

All aforementioned sets were designed to operate simultaneously, that is, (see FIGS. 10, 11 and 12) to fold, shape and weld the box (1), whose central part has a square area adjustable on the shaping device (20), in which the ram (21) operation makes all creases (V) to be orderly folded until the packaging takes the appearance of FIG. 12 and then the double welding device comes near and performs the welding lines (13), completing a welding cycle.

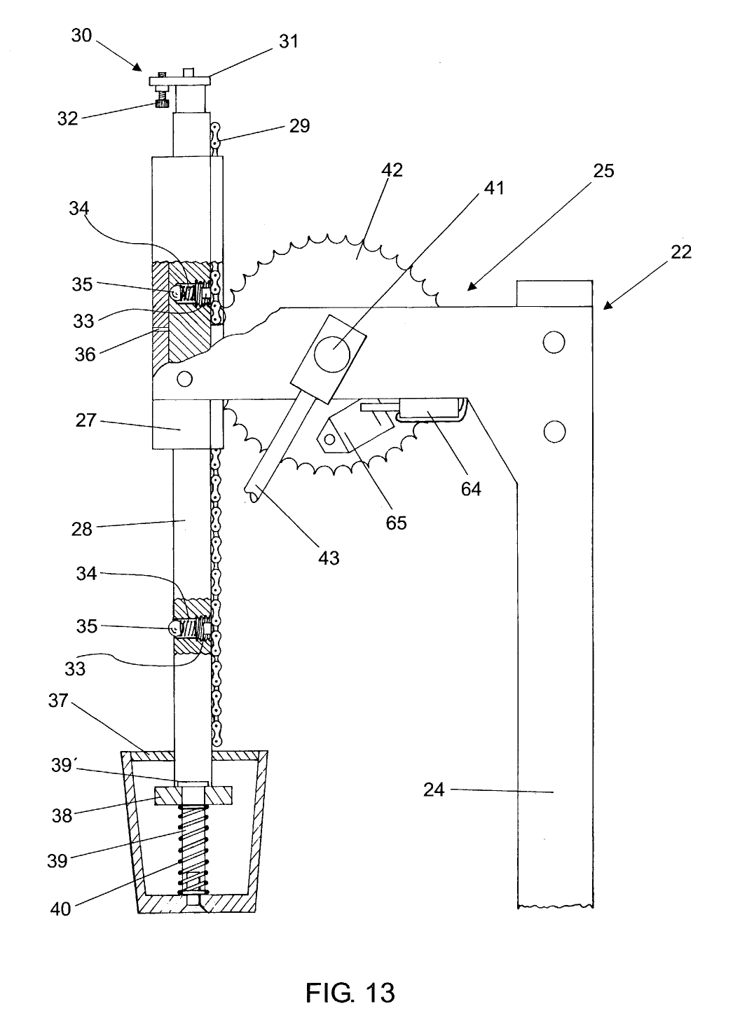

To perform the aforementioned operations, each set presents a number of particularities, starting with the ram device (21), shown in detail in FIG. 13, where one may see that it consists initially of a vertical guide in the form of a “U” bushing (27), along which a vertical rod of square section (28) slides, in whose back surface a chain (29) extends longitudinally, having its ends fixed on the upper and lower ends of said square rod (28), where it is coupled to the driving device (25).

The ram (21) includes a supplement installed in its upper end, defined as and end-of-course regulating and fine-tuning device (30), consisting of a support (31) and a screw (32), the latter vertically oriented downwards and operating as the adjustable stop top when it hits the guide (27) and the ram (21) attains its lowest course.

The ram (21) has also two stop top points, one for the upper course limit and the other for the lower course limit, both of them consisting of a screw (33), a spring (34) and a ball (35), the last being kept pressed against the guide duct (27), where there is a hole (36) that, in turn, operates as partial housing, defining a stop point with a slight locking for the balls (35) and consequently, such slight locking enables the ram set (21) to be stopped when totally displaced upwards or when totally displaced downwards.

The ram (21) has its lower end provided with a shaping block (37) pyramidal trunk and exactly with the same volume and shape as the box (1) after it is shaped, and such block is hollow and fixed in a spring-type manner to the lower end of the rod (28) that, for this reason, receives a built-in rectangular horizontal plate (38), whose ends are crossed by two guides (39), with upper heads (39′), whereas their lower ends are fixed by screws to the block bottom wall (37), where each guide (39) is involved by a helical spring (40), whose upper end is supported under the plate (38), while its lower end is supported on the block bottom (37), enabling the block to be displaced upwards only when it exceeds the pressure of such spring (40), giving it a floating effect.

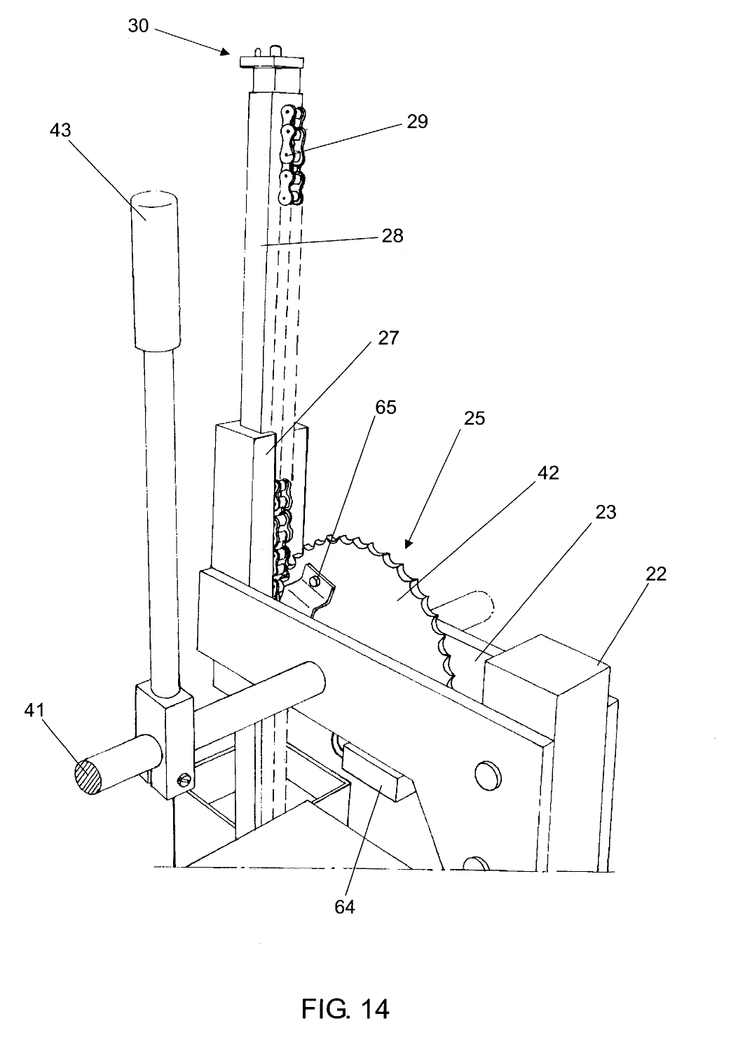

The transmission and driving mechanism (25) is also illustrated in detail in FIGS. 14, 15 and 16, which show that such mechanism consists of a horizontal axis (41), supported on the branch (23) of the L shaped support (22), where the median part of such axis has a built-in mounted gear (42), which is kept geared with the chain (29), and also, in addition to said axis including a driving lever (43), fixed on a radial position, the two ends of said horizontal axis (41) are equally equipped with other built-in gears (44), both coupled in chains (45), stretched downwards, where they are fitted with other smaller gears (46) that, in turn, are fixed on the ends of two inversely threaded fuses (47), each fuse being horizontally supported on a nut-type bearing (48), after which the other end of such fuse is mounted in a sliding manner on another bearing (49), where said end is coupled to the double-welding set (19).

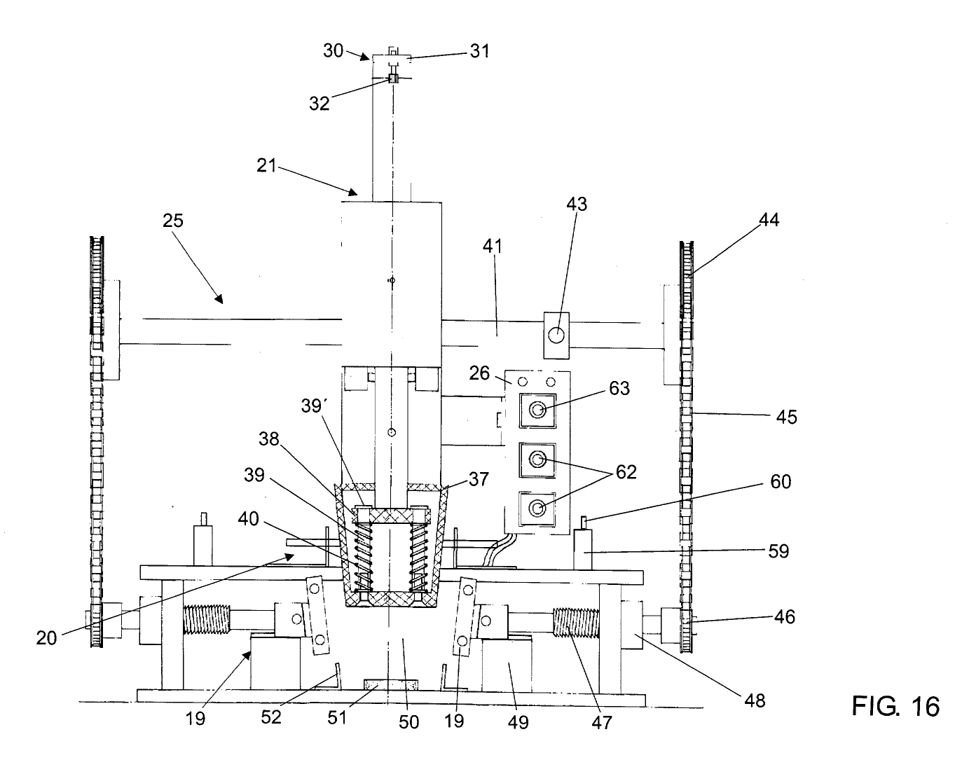

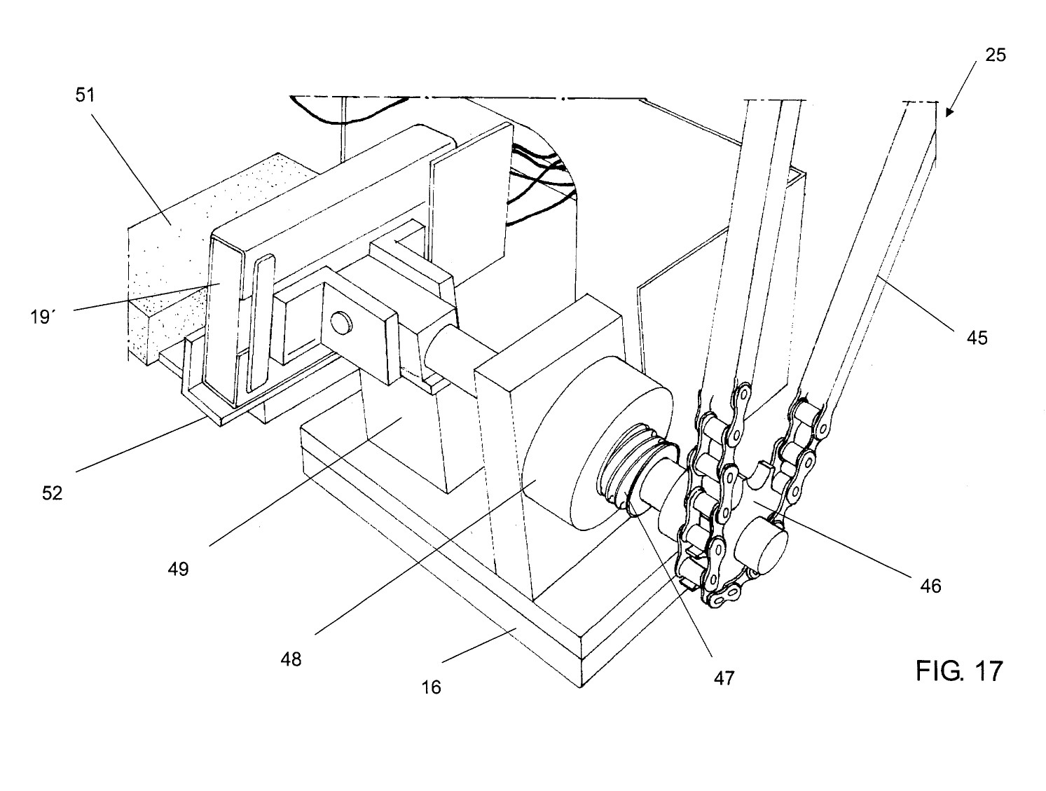

In relation to FIGS. 16 and 17, the double welding set (19) consists of two welding shoes (19′), slightly inclined according to the tapering of the block (37) and of the box (1), so that a clear space may be formed (50) between the two shoes, limited on their lower side by a foam board (51) and laterally, by two brackets (52) and by the platform (16), configuring a supporting cradle for the box (1) at the end of the welding operation.

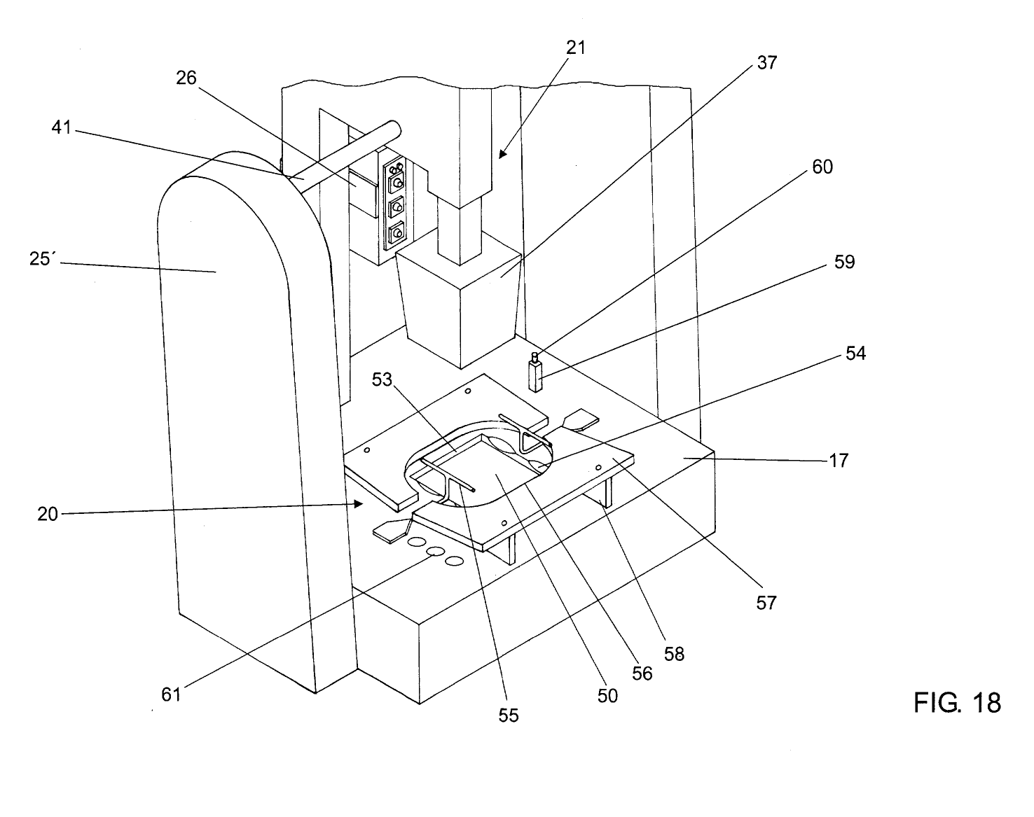

As shown in FIG. 18, the shaping device (20) initially consists of a square opening (53) placed on the upper platform (17), whose opening is positioned on the upper part of that space (50), and also, at such opening, the lateral borders are limited by arched segments (54), two on each side, between which trimmers practically in a “T” shape are 10 elevated (55), one on each side, which are circumscribed by another more elevated and almost elliptical opening (56), defined by a pair of elevated plates (57) with respective supports (58), which plates are slightly inclined on the transversal median point of the base (15) that finally includes two small towers (59) with positioning ends (6) for the planar box (1), as shown in figure (10).

The platform (17) includes several ventilation openings (61), so that the heat produced by the welding set (19) is more easily dissipated.

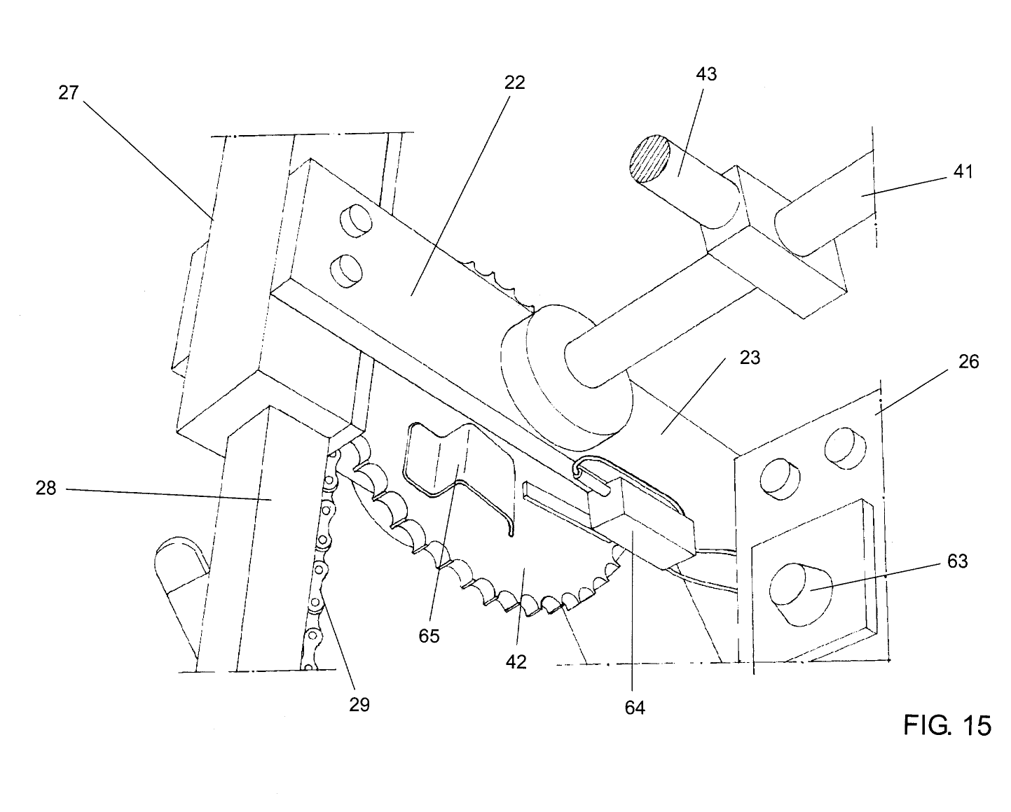

In relation to FIGS. 15 and 16, the electrical control panel (26) includes not only the pilot lamps but also an adjustable thermostat (62) for each welding shoe (19′) and an adjustable sound timer (63) indicating the end of the welding, and the last is connected to a micro-switch (64) mounted on the horizontal part (23) of the support (22), where such micro-switch is turned on and off by a cam (65) fixed on the gear itself (42).

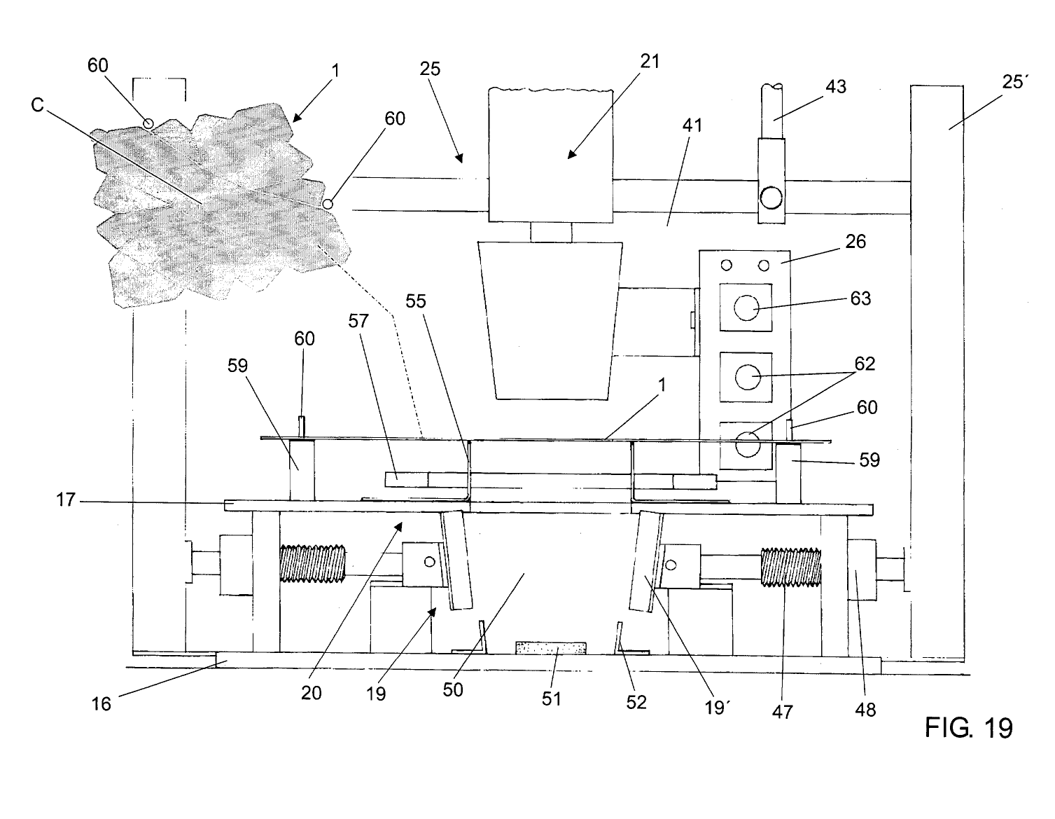

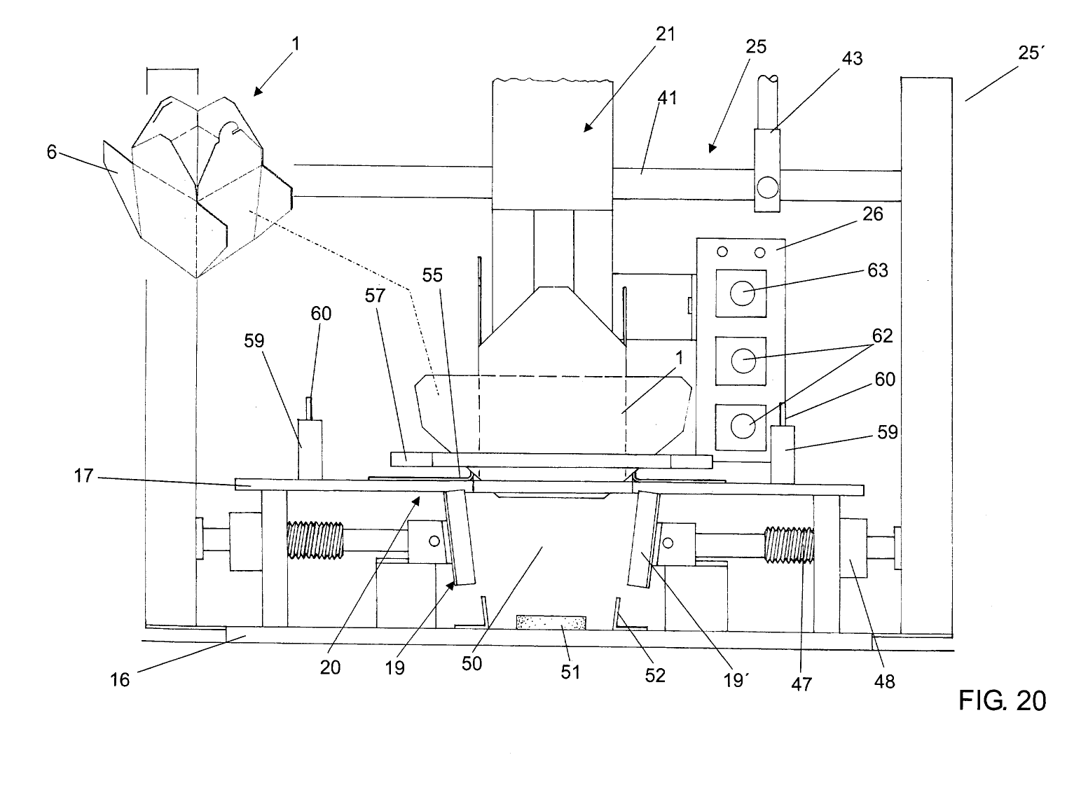

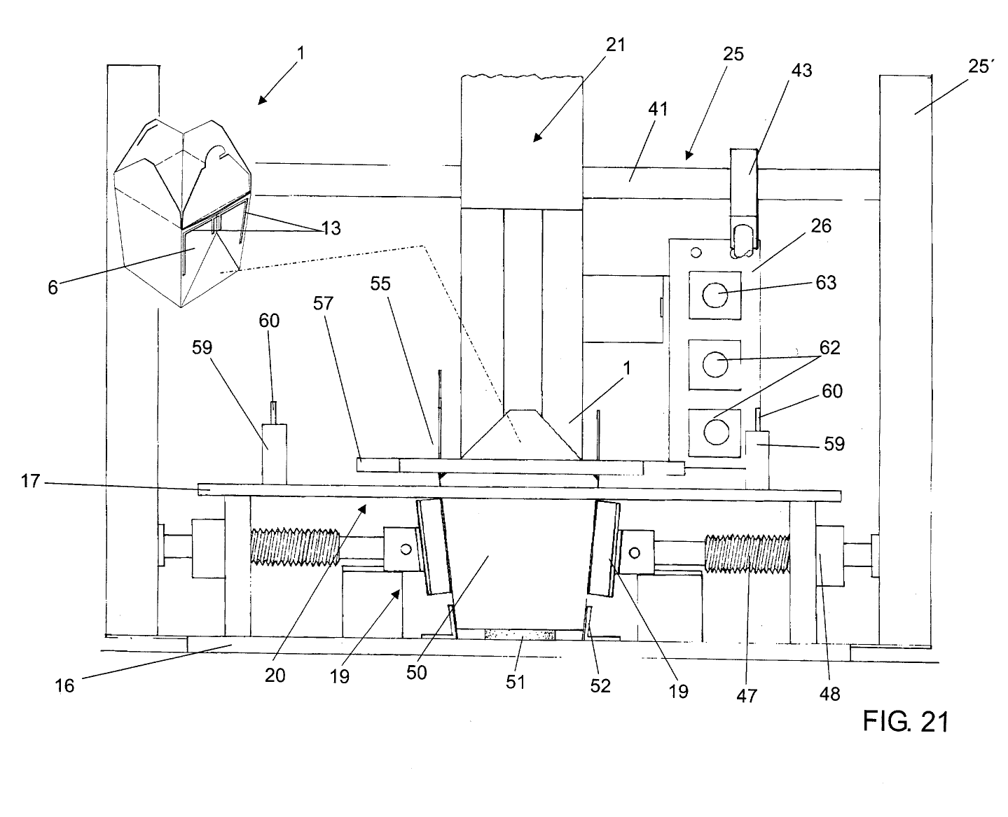

The operation of this machine is actually very simple, as shown in FIG. 19. When the machine is turned on and duly warmed, the ram (21) should be in its highest position and, in such position, the upper part of the shaping device (20) remains free so 25 that the extended or planar box (1) is positioned on the two “T” trimmers (55), also having the towers (59) as a positioning backing and respective ends (60) through which the positioning of the laminar part of the box (1) is performed very easily. When this operation is completed, the operator should merely drive the ram (21) downwards through its lever (43) and the shaping block (37) will consequently act against the central part (C) of the planar box forcing it downwards to the space (50), and consequently all parts limited by creases that are around such central part (C) start to be folded as shown in FIG. 20, where one may sees that all lateral walls of the box (1) are adjusted against the lateral sides of the shaping block (37) while the rims (6) are shaped according to the details (54-55) of the shaping device (20). Continuing the movement downwards, as shown in FIG. 21, the rims (6) of the box (1) are displaced against the respective lateral walls and at this time the fuses (47) are displaced against the lateral walls of the box (1) and the welding lines (13) are consequently made. In this stage, the cam (65) also starts to operate by turning on the micro-switch (64) at the same time as the timer (63) is turned on, starting the counting of the time sufficient to form the welding lines (13) and with a sound signal, the time determined for such operation is completed, so that the operator may move the lever (43) upwards, until the ram (21) returns to its original position and after that the shaped and welded packaging may be removed from the device to be used.

It should be noted that the welding lines (13) always follow the internal contour defined by the borders free of the rims (6) no matter the geometrical configuration adopted for them.

Therefore, by diversifying the drawing of the inner face welding trail of the welding plate (19) one may obtain different welding lines (13); however, in any situation, such welding line (13) configures a tight seal of that interstice (10).

As it may be noticed from what has been exposed and illustrated, with the use of the welder in question all those technical and practical advantages are achieved, that is, the welding (13), in addition to being actual seals, also contribute to a better fixation of the rims (6) against the lateral walls of the box (1), also improving its structural effect, mainly when two or more boxes are stacked.

On the other hand, the welder in question, although semi-automatic, presents advantageous characteristics that exceed the quality provided by the first aforementioned welder.

I claim:

1. SEMI-AUTOMATIC WELDER TO CLOSE DISPOSABLE BOXES, characterized by the fact that it consists of a basic part (15), usually in the shape of a box, defined by two platforms, a lower (16) and an upper (17) platform, defining two assembly levels, an upper and a lower assembly level, and the latter, in addition to including a plate surrounding closing (18), also defines means for built-in assembly of the double-welding set (19), whereas the upper level or platform (17) configures means to assemble the shaping device (20), above which the ram device (21) is vertically aligned, mounted on a support that usually has an inverted “L” shape (22), defined by a horizontal (23) and a vertical (24) branch, the first being crossed by a transmission and driving mechanism (25) protected by plate surrounding devices (25′), one on each side, and also such transmission and driving mechanism (25) is, on the one side, operatively coupled for vertical and alternated operation of the ram (21) and, on the other side, it is equally coupled to horizontally operate the double-welding set (19) that, in turn, is electrically interconnected with an electrical control panel (26), mounted on the back of the base (1).

2. SEMI-AUTOMATIC WELDER, according to claim 1, characterized by the fact that the ram device (21) consists of a vertical guide in the form of a “U” bushing (27), along which a vertical rod of square section (28) slides, in whose back surface a chain (29) extends longitudinally, having its ends fixed on the upper and lower ends of said square rod (28), where it is coupled to the driving device (25).

3. SEMI-AUTOMATIC WELDER, according to claim 2, characterized by the fact that the ram (21) includes a supplement installed in its upper end, defined as and end-of-course regulating and fine-tuning device (30), consisting of a support (31) and a screw (32), the latter vertically oriented downwards and operating as the adjustable stop top when it hits the guide (27) of the ram (21).

4. SEMI-AUTOMATIC WELDER, according to claim 2, characterized by the fact that the ram (21) has two stop top points, one for the upper course limit and the other for the lower course limit, both of them consisting of a screw (33), a spring (34) and a ball (35), the last being kept pressed against the guide duct (27), where there is a hole (36) that, in turn, operates as partial housing, defining a stop point with a slight locking for the balls (35) when the ram set (21) attains its highest or lowest position.

5. SEMI-AUTOMATIC WELDER, according to claim 2, characterized by the fact that the ram (21) presents its lower end provided with a shaping block (37) pyramidal trunk and exactly with the same volume and shape as the box (1) after it is shaped, and such block is hollow and fixed in a spring-type manner to the lower end of the rod (28) that, for this reason, receives a built-in rectangular horizontal plate (38), whose ends are crossed by two guides (39), with upper heads (39′), whereas their lower ends are fixed by screws to the block bottom wall (37), where each guide (39) is involved by a helical spring (40), whose upper end is supported under the plate (38), while its lower end is supported on the block bottom (37).

6. SEMI-AUTOMATIC WELDER, according to claim 1, characterized by the fact that the transmission and driving mechanism (25) consists of a horizontal axis (41), supported on the branch (23) of the L shaped support (22), where the median part of such axis has a built-in mounted gear (42), which is kept geared with the chain (29), and also, in addition to said axis including a driving lever (43), fixed on a radial position, the two ends of said horizontal axis (41) are equally equipped with other built-in gears (44), both coupled in chains (45), stretched downwards, where they are fitted with other smaller gears (46) that, in turn, are fixed on the ends of two inversely threaded fuses (47), each fuse being horizontally supported on a nut-type bearing (48), after which the other end of such fuse is mounted in a sliding manner on another bearing (49), where said end is coupled to the double-welding set (19).

7. SEMI-AUTOMATIC WELDER, according to claim 1, characterized by the fact that the double-welding set (19) consists of two welding shoes (19′), slightly inclined according to the tapering of the block (37) and of the box (1), so that a clear space may be formed (50) between the two shoes, limited on their lower side by a foam board (51) and laterally, by two brackets (52) and by the platform (16).

8. SEMI-AUTOMATIC WELDER, according to claim 1, characterized by the fact that the shaping device (20) initially consists of a square opening (53) placed on the upper platform (17), whose opening is positioned on the upper part of that space (50), and also, at such opening, the lateral borders are limited by arched segments (54), two on each side, between which trimmers practically in a “T” shape are elevated (55), one on each side, which are circumscribed by another more elevated and almost elliptical opening (56), defined by a pair of elevated plates (57) with respective supports (58), which plates are slightly inclined on the transversal median point of the base (15) that finally includes two small towers (59) with positioning ends (6) for the planar box (1).

9. SEMI-AUTOMATIC WELDER, according to claim 8, characterized by the fact that the platform (17) includes several ventilating openings (61).

10. SEMI-AUTOMATIC WELDER, according to claim 1, characterized by the fact that the electrical control panel (26) includes not only the pilot lamps but also an adjustable thermostat (62) for each welding shoe (19′) and an adjustable sound timer (63) indicating the end of the welding, and the last is connected to a micro-switch (64) mounted on the horizontal part (23) of the support (22), where such micro-switch is turned on and off by a cam (65) fixed on the gear itself (42).
